(19) United States
(12) Patent Application Publication
(10) Pub. No.: US 2025/0171282 A1
(43) Pub. Date: May 29, 2025

(54) Manually Operated, Hydraulic Lowering Device for Lifting Equipment

(71) Applicant: Stromag France SAS, La Guerche sur l'Aubois (FR)

(72) Inventor: David Babise, Pougny (FR)

(21) Appl. No.: 18/956,090

(22) Filed: Nov. 22, 2024

(30) Foreign Application Priority Data
Nov. 24, 2023 (FR) 2313005

(51) Int. Cl. B66D 5/26; B66D 5/12

(52) U.S. Cl. CPC B66D 5/26; B66D 5/12

(57) ABSTRACT

A hydraulic lowering device for a safety brake of lifting equipment includes a fluid reservoir (1), a fluid outlet port (18), a pressurized fluid accumulator (2), a pump (3, 3′) connected to the fluid reservoir for injecting pressurized fluid from the fluid reservoir into the pressurized fluid accumulator, and a three-way pressure regulator (4) including a mechanical control input, actuated via a handwheel (5), for setting a setpoint value, a fluid inlet connected to the pressurized fluid accumulator (2), a fluid outlet connected to the fluid outlet port (18), and a drain connected to the fluid reservoir (1). The three-way pressure regulator (4) enables precise and completely safe control of the release, reinforcement and attenuation of braking. The dissociation between establishing, by pumping, a reserve of energy into the pressurized fluid accumulator (2) and controlling the lowering via the three-way pressure regulator (4) facilitates control.

### TECHNICAL FIELD

The present application concerns a manually operated hydraulic lowering device for lifting equipment.

### PRIOR ART

Lifting equipment such as cranes, overhead traveling cranes, etc. usually comprises a line provided with a drum around which suspension cables are wound, to which the load to be lifted is attached. Such lifting equipment can be used to lift extremely heavy loads, for example weighing over 50 tons, and whose weight is sometimes not the only source of danger (the load may, for example, be radioactive material or a bucket filled with molten metal).

Lifting equipment requires brakes for a number of functions, including: slowing and stopping the load as it approaches a stop position (service brake); locking the lifting equipment in its stop position, that is, when the load is at the desired height (parking brake); stopping and locking the lifting equipment in the event of a power failure or, more generally, in the event of an emergency of any kind (safety brake, also called failsafe brake).

In particular, a failsafe brake is configured to activate when it is no longer supplied with electricity (in the event of a power failure): this is known as a power failure brake or negative brake. Since the 1960s, disc brakes have become the preferred choice for this application, particularly as their heating properties pose little or no problem.

A failsafe brake generally comprises:
a disc secured to the line to be braked,
a clamp, comprising two plates capable of clamping the disc, which plates are generally fitted with friction pads,
for each plate or for one of the two plates only, a washer spring configured to impose a compression force on said plate in the closing direction of the brake, that is, so as to push and hold the plates under pressure against the disc and thus close and tighten the clamp,
an actuator, which may be electrohydraulic, electromagnetic or electromechanical, and which presses against one end of the washer spring so as to compress it in the direction of brake opening; when the actuator is energized, it compresses the washer spring, opening the clamp and releasing the disc (and therefore the line) for rotation.

In the event of a power failure, the actuator suddenly becomes inoperative, releasing the washer spring which closes the brake. The load is then stopped and remains suspended in the air.

The load must then be lowered, even though the power may not yet be restored. This operation is carried out using a hydraulic lowering device, which slightly reopens the safety brake, allowing the line to rotate and the load to be lowered.

Both electromagnetic and electromechanical safety brakes are equipped with a hydraulic release chamber and a “hydraulic release” connection to which an operator can connect a hydraulic lowering unit when a lowering operation is required.

Hydraulic brakes are by definition managed by a hydraulic system, whether already integrated into the brake or not, and include a main hydraulic chamber for day-to-day brake management, and are generally equipped with a “lowering option” that allows the brake's hydraulic management system to be controlled.

In every case, the brake features a hydraulic chamber wherein a fluid (e.g., oil) under pressure can be injected, which hydraulic chamber bears against one end of the brake's washer spring so as to compress said spring in the direction of brake opening. In the following, this hydraulic chamber is referred to as the brake's hydraulic release chamber, even when the brake is an electrohydraulic brake and the chamber in question is not only a release chamber but also the brake's main operating chamber.

In the known brakes (whatever the nature of the brake), lowering has to be managed by an operator from the lifting bridge or the top of the crane, in an uncomfortable and dangerous position at height.

In the known brakes (whatever the nature of the brake), the hydraulic release device built into the brake or connected to it when a lowering operation is required is equipped with a fluid reservoir, a lever-operated hand pump which supplies a volume of fluid following action on its lever, and a flow limiter which maintains a permanent controlled leak to the reservoir.

The combination of pump flow and leakage flow generates back pressure in the brake's hydraulic chamber, counteracting the force of the washer spring via the hydraulic release device.

When the back pressure produces a force just above the clamping force required to hold the load, sliding begins and the load descends.

Although functional on paper, in practice, pressure adjustment in the hydraulic chamber is only possible by matching the pumping frequency to the leakage rate.

In order to balance the volume of fluid injected into the hydraulic brake release chamber, the operator must adjust the pumping force and speed throughout the lowering operation, both of which vary according to the expected pressure, causing stress, fatigue and risk.

Known lowering devices are very difficult to operate, and do not allow the load to be lowered in a slow, controlled manner. In fact, they do not allow the operator to “feel” the pressure in the brake's hydraulic chamber, nor to easily regulate this pressure. In practice, the lowering device can end up reacting in an all-or-nothing manner: while the brake is still applied, a single additional action on the pump lever can lead to a rapid and significant increase in pressure in the hydraulic release chamber, resulting in the brake opening and the subsequent drop of load.

In addition, not only is the device devoid of means for controlling the pressure in the hydraulic release chamber, but once the equilibrium pressure has been exceeded, the lowering device does not allow the operator to act to reduce in a controlled manner the quantity and/or pressure of fluid in the hydraulic chamber in order to slightly re-close the brake so as to slow the fall of the load.

It should be noted that “equilibrium pressure” of the brake refers to the fluid pressure in the hydraulic release chamber that compresses the washer spring (in the direction of brake opening) but does not disengage the pads from the disc; in other words, the fluid pressure that enables the hydraulic chamber to exactly counteract the force exerted by the spring on the clamp plates to hold the load. When this equilibrium pressure is reached in the hydraulic chamber, the load is no longer held by the brake, even though it is not actually open.

For the load to be lowered in a slow, gradual and controlled manner, the pressure in the chamber must be both higher than this equilibrium pressure, so that the brake pads do not exert a force likely to block the disc, and close enough to it for the pads to press sufficiently on the disc to slow the load's descent.

### DISCLOSURE OF THE INVENTION

The invention aims to overcome at least one of the aforementioned disadvantages by providing a lowering device for lifting equipment, which enables a load to be lowered in a controlled manner in complete safety, and which is easy to maneuver and safe for the operator.

To this end, the invention proposes a hydraulic lowering device for a safety brake of lifting equipment, intended to be used with a brake provided with a hydraulic release chamber and a fluid inlet connection, the so-called release connection, the lowering device comprising a fluid reservoir and a fluid outlet port. The lowering device according to the invention is characterized in that it comprises:
a pressurized fluid accumulator, connected to the fluid reservoir,
a pump connected to the reservoir to inject pressurized fluid from the reservoir into the accumulator,
a three-way pressure regulator comprising a mechanical control input for setting a setpoint, a fluid inlet connected to the accumulator, a first fluid outlet connected to the fluid outlet port of the lowering device, and a second fluid outlet, the so-called drain, connected to the reservoir,
a manual actuator for the pressure regulator control input,
an extension for fluid connection from the fluid outlet port to the safety brake release connection.

The lowering device according to the invention is used as follows:
when a lowering operation is required, an operator connects the lowering device to the safety brake release connection, via the lowering device extension,
initially, the operator concentrates on creating an energy reserve; he operates the pump to pressurize the fluid in the accumulator until a pressure is reached in the accumulator corresponding, for example, to the maximum permissible pressure in the brake's hydraulic chamber, or preferably corresponding to the maximum permissible pressure in the accumulator,
in the second stage, the operator concentrates on the actual control, adjusting the pressure in the brake's hydraulic chamber by manipulating the manual actuator of the three-way pressure regulator's control input, in order to control the descent of the load.

Thus, the invention is based on the combination of two principles:
decoupling between the pressurization of the fluid intended to be injected into the hydraulic brake release chamber, and the injection of this fluid into the said chamber, that is, decoupling between the physical action of pumping (which requires power) and the action of adjusting the pressure (which requires finesse, precision and attention), this decoupling being made possible by the provision of an accumulator in the lowering device;
controlling the pressure in the brake's hydraulic chamber, thanks to the provision of a three-way pressure regulator between this accumulator and the fluid outlet port of the lowering device; lowering is therefore carried out by regulating pressure and not volume or flow rate, as is the case with known lowering devices.

In addition, the use of a three-way pressure regulator makes it possible to control the pressure in the hydraulic brake release chamber in both directions:
if the setpoint value requested at the regulator control input is higher than the regulator output pressure, that is, the fluid pressure in the brake release hydraulic chamber, the pressure regulator places the fluid inlet in communication with the fluid outlet of the regulator, that is, the accumulator and brake release circuit respectively; the fluid flows in the direction of the brake and the pressure in the release hydraulic chamber rises, thus attenuating the brake;
if the setpoint is lower than the fluid pressure in the brake's hydraulic release chamber, the regulator places in communication the regulator's fluid outlet and the drain, that is, the brake and the reservoir respectively; the fluid flows from the hydraulic release chamber to the reservoir, reinforcing the brake,
if the setpoint is equal to the fluid pressure in the hydraulic brake release chamber, the pressure regulator closes all three channels, corresponding to a stable lowering phase in which the braking force is slightly less than the load force.

In addition, once the extension cable has been connected to the brake, the lowering device can be used from the ground, allowing the operator to settle into a stable, comfortable posture, which is not insignificant given that a lowering operation can take several hours, depending on the load involved.

In addition, the device according to the invention has the advantage of being compatible with the vast majority of known safety brakes, in particular all safety brakes with hydraulic actuators and all electromagnetic or electromechanical safety brakes with a hydraulic release option.

According to particular embodiments of the invention, the lowering device further complies with the following features, implemented individually or in any technically possible and operative combination.

In some embodiments, the lowering device comprises a safety stop device, known as a dead man's safety device, comprising a safety lever configured to be movable by an operator between a passive locking position which prevents the injection of fluid into the brake release hydraulic chamber and an active unlocking position which allows the injection of fluid into the brake release hydraulic chamber, the safety lever being automatically returned to its passive locking position in the absence of operator action.

The dead man's safety device guarantees totally safe lowering. At any moment, the load can be instantly stopped by releasing the safety lever.

In some embodiments, the lowering device further comprises:
a first pressure sensor for measuring the fluid pressure at the inlet to the three-way pressure regulator, and first display means associated with said first sensor for displaying the measured pressure,
a second pressure sensor for measuring the fluid pressure at the fluid outlet port of the lowering device or at the outlet of the pressure regulator, and second display means associated with said second sensor for displaying the measured pressure.

The first pressure sensor and the first associated display means (with said first sensor) are, for example, a first pressure gauge capable of measuring pressures up to 250 bar, and the second pressure sensor and the second display means (associated with said second sensor) are, for example, a second pressure gauge capable of measuring pressures up to 150 bar.

These pressure sensors and associated display means make it possible to determine and monitor the pressure available in the accumulator, which corresponds to the pressure at the pressure regulator inlet, and the pressure prevailing in the hydraulic brake release chamber, which corresponds to the fluid pressure at the device's fluid outlet port and which preferably also corresponds to the pressure at the pressure regulator outlet. The usefulness of these pressure sensors and associated display means will be better understood on reading the description detailed below.

In some embodiments, the brake release device comprises, in parallel with the pressure regulator, a fluid return circuit between the fluid outlet port and the reservoir, enabling the brake release chamber to be emptied into the reservoir. As will become clear later, this return circuit also contributes to the safety of the lowering device and the brake, in combination with the dead man's safety device and a pressure relief valve (described later) respectively.

In some embodiments, the lowering device comprises a movable carriage on which all the device components are mounted. This movable carriage contributes to the ergonomics of the device according to the invention, in that it enables the operator to easily position himself in the most appropriate place to control the lowering.

In some embodiments, the pump can be: a hand pump, e.g., a piston pump activated manually by a lever; a motorized pump, e.g., a rotary gear pump associated with a screwdriver, the pump comprising a gear provided with a recess for receiving a screwdriver bit for rotating said gear by said screwdriver. The screwdriver is fitted with a battery so that it can be powered in all circumstances (especially in the event of a power failure).

The device can comprise several pumps, each connected to the reservoir, including, for example, a hand pump and a motorized pump.

In some embodiments, the lowering device comprises:
a main manifold to which the reservoir, the pump and a pressurization hose connecting the accumulator to said main manifold are connected, and
a secondary manifold to which are connected the pressure regulator, a supply hose connected to the accumulator via the main manifold, a return hose connected to the reservoir via the main manifold, and the fluid outlet port of the lowering device, as well as the first and second pressure sensors where present.

In some embodiments, the lowering device comprises a pressure limiter between the accumulator and the reservoir, configured to limit the fluid pressure injected into the accumulator.

In some embodiments, the return circuit (between the fluid outlet port and the reservoir) comprises a further pressure limiter configured to limit the fluid pressure that is injected via the fluid outlet port into the brake's hydraulic release chamber.

In some embodiments, the dead man device comprises:
a first solenoid valve on the return circuit, which first solenoid valve is configured to be open when the safety lever is in the passive locking position and to be closed when the safety lever is in the active unlocking position, and
a second solenoid valve at the pressure regulator input, which second solenoid valve is configured to be closed when the safety lever is in the passive locking position and to be open when the safety lever is in the active unlocking position.

The invention extends to a method of lowering a load on lifting equipment, characterized in that it uses a lowering device as previously defined, and in that it comprises:
a step of pressurizing the accumulator during which at least some of the fluid present in the reservoir is injected into the accumulator by activating the pump;
a step of controlling the pressure at the outlet of the pressure regulator by means of the manual actuator of the pressure regulator control input, so as to control the lowering of a load carried by the lifting equipment,
the pressurization and controlling steps are carried out successively, independently of one another.

Preferably, the accumulator is pressurized until the maximum pressure that said accumulator can withstand is reached. During lowering, if necessary, that is, if the pressure at the pressure regulator inlet becomes insufficient, the operator can stop the load's descent by imposing a setpoint value on the regulator which is low enough to apply the brake, stop controlling to re-pressurize the accumulator using the pump, and then resume controlling once the accumulator has been “re-inflated”. Preferably, the operator re-inflates the accumulator until the maximum permissible accumulator value is reached at the regulator input, to avoid having to re-inflate the accumulator frequently.

### BRIEF DESCRIPTION OF THE DRAWINGS

The invention, according to an embodiment, will be well understood and its advantages will become clearer on reading the following detailed description, given by way of indication and in no way limitingly, with reference to the appended drawings, wherein:

FIG. 1 is a perspective view of a first exemplary embodiment of a hydraulic lowering device according to the invention;

FIG. 2 shows the exemplary embodiment shown in FIG. 1, seen in perspective from an opposite viewpoint;

FIG. 3 is a perspective view of part of a second exemplary embodiment of a hydraulic lowering device according to the invention;

FIG. 4 is an exploded perspective view of a third exemplary embodiment of a device according to the invention;

FIG. 5 is a hydraulic diagram of the exemplary embodiment shown in FIG. 4.

### DETAILED DESCRIPTION

Identical elements shown in the above figures are identified by identical numerical references.

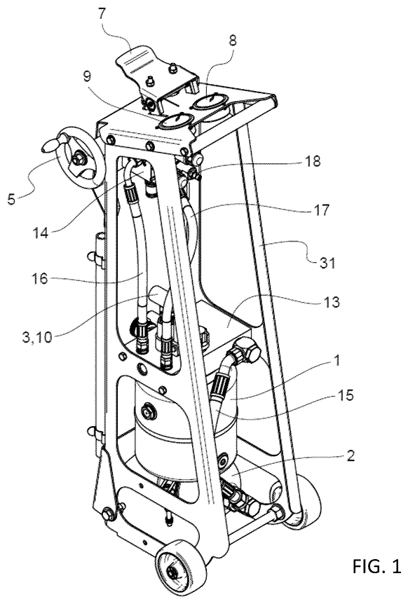

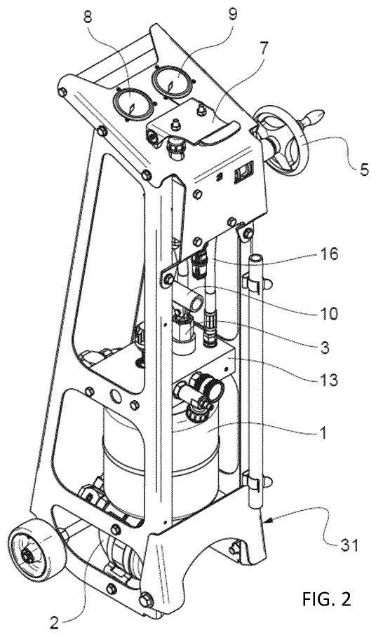

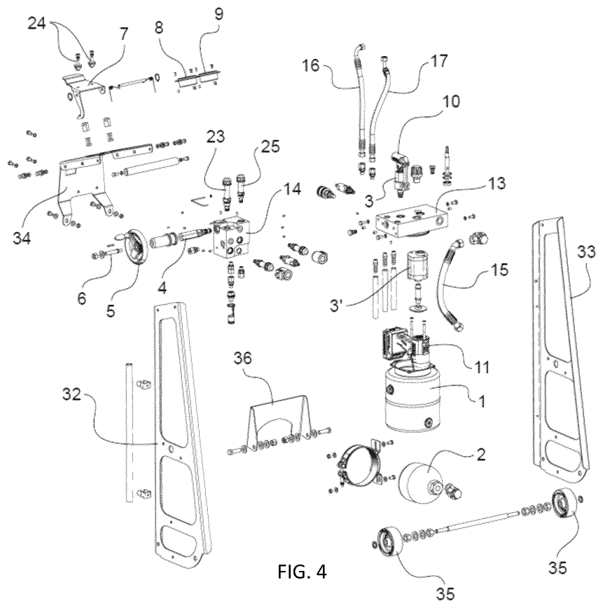

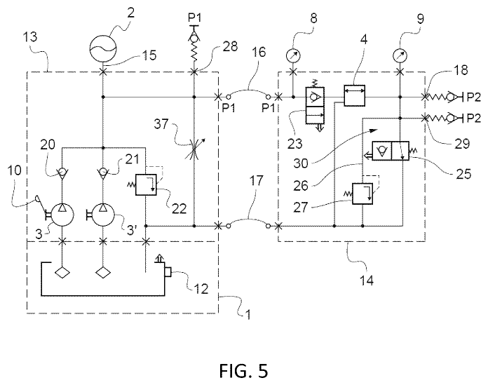

FIGS. 1 and 2 show a first exemplary embodiment of a lowering device according to the invention. Reference is also made to FIGS. 4 and 5 for the parts in common between this first exemplary embodiment and the third exemplary embodiment shown in these FIGS. 4 and 5.

The lowering device according to the invention shown in FIGS. 1 and 2 comprises:
a reservoir 1 containing a fluid such as oil,
an accumulator 2 capable of withstanding a pressure of 200 bar, for example,
a piston pump 3 that can be manually actuated by a lever 10,
a main manifold 13 and a secondary manifold 14, which facilitate the hydraulic connection of some of the elements of the lowering device to one another (see below),
a three-way pressure regulator (see FIGS. 4 and 5), also more simply referred to as a pressure regulator—or regulator—throughout this description,
a handwheel 5 for controlling the pressure at the outlet of the pressure regulator, which corresponds to the pressure in the hydraulic chamber of the brake, the shaft 6 of said handwheel (see FIG. 4) being fitted into the control inlet of the pressure regulator.
a dead man's safety device comprising in particular a safety lever 7,
a collar pressure gauge 8 for measuring and displaying the pressure at the inlet to pressure regulator 4,
a collar pressure gauge 9 for measuring and displaying the pressure at the outlet of regulator 4,
a fluid outlet port 18 to which the operator connects the end of a hose (not shown), referred to as an extension, the opposite end of said extension being connected to a fluid inlet connection of the safety brake,
a fluid return circuit 30 (see FIG. 5) connecting the fluid outlet port 18 to the reservoir 1.

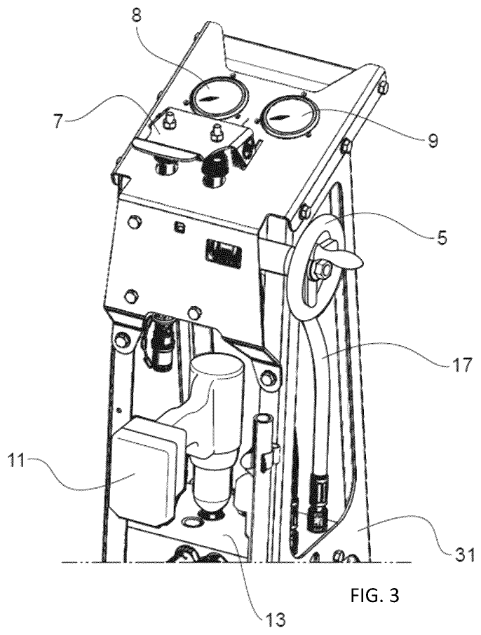

The second exemplary embodiment shown in FIG. 3 differs from the first in that its pump is a motorized submersible pump 3′ (see FIG. 4) comprising a gear driven by a screwdriver 11.

The third example shown in FIG. 4 differs from the two previous examples in that it comprises two pumps, including a submersible pump 3′ driven by a screwdriver 11, similar to the pump in the second example, and a hand pump 3 actuated by a lever 10, similar to that in the first exemplary embodiment.

Reference is now made to the hydraulic diagram shown in FIG. 5, which is valid for all three proposed exemplary embodiments, with the exception of the presence of two pumps, which only applies to the third example.

The dotted lines represent the reservoir 1, the main manifold 13 and the secondary manifold 14 respectively.

Pumps 3 and 3′ are connected to the reservoir 1 on the one hand, and to the main manifold 13 on the other, enabling the fluid in reservoir 1 to be injected into accumulator 2 via the main manifold 13, to which accumulator 2 is connected via a first hose 15, the so-called pressurization hose, and via non-return valves 20 (for hand pump 3) and 21 (for gear pump 3′).

A pressure relief valve 22, also mounted on the main manifold 13, prevents the accumulator from being inflated beyond its maximum permissible pressure by returning the pumped fluid to reservoir 1 when this pressure is reached.

In addition, the reservoir 1 is usually fitted with a level sensor 12.

A second hose 16, known as the supply hose, extending between the main manifold 13 and the secondary manifold 14, connects the accumulator 2 to the fluid inlet of the pressure regulator 4.

The collar pressure gauge 8 measures and displays the pressure P1, which corresponds to both the fluid pressure in accumulator 2 and the fluid pressure at the inlet to pressure regulator 4. Collar pressure gauge 9 measures and displays pressure P2, which corresponds to the pressure at the outlet of pressure regulator 4, the pressure at fluid outlet port 18 of the lowering device and the pressure in the brake release hydraulic chamber.

When the operator uses the handwheel 5 to increase the set pressure at the pressure regulator's control input, the pressure P2 at the regulator's output increases accordingly, and fluid is injected into the brake release hydraulic chamber via the extension.

When the operator actuates handwheel 5 to reduce the set pressure, output pressure P2 decreases and fluid flows in the opposite direction, from the brake to the lowering device. The fluid is then returned to the reservoir 1 via the return circuit 30, and in particular via a line 26, provided in the secondary manifold 14, and then via a third hose 17, known as the return hose, extending between the secondary manifold 14 and the main manifold 13.

Optionally, but advantageously, a pressure limiter 27 is provided on the return line 26 in order to secure the brake. If, through clumsiness or error, the operator imposes a pressure setpoint on the control input of pressure regulator 4 which exceeds the pressure supported by the brake's hydraulic release chamber, pressure limiter 27 opens and some of the fluid is directed to the reservoir instead of to the brake.

The presence of this pressure limiter 27 means that the lowering device can be used without risk for any type of brake, not only for brakes whose hydraulic release chamber can withstand up to 180 bar (such as a safety brake designed for lifting equipment that can carry several tens or even hundreds of tons), but also for less powerful brakes whose hydraulic release chamber is limited to 20 bar, for example. In the absence of such a pressure limiter 27, one way of reducing the risk of brake damage is to limit the pressure P1 at which the accumulator is pre-inflated, by stopping the accumulator pressurization stage when the pressure P1 approaches the maximum pressure supported by the brake's hydraulic release chamber (which is a known technical specification of the brake).

The dead man's device comprises a safety solenoid valve 25 on the fluid return circuit 30. Solenoid valve 25 is actuated by a progressive stop 24 (see FIG. 4) pressed down by safety lever 7. When the operator presses the safety lever 7, the safety solenoid valve 25 is closed and the pressure at the output of the regulator 4 is sent to the brake, or possibly to the return line 26 if the maximum pressure supported by the brake is exceeded.

Release of safety lever 7 causes the progressive stop 24 to return, solenoid valve 25 to open and the pressure regulator output circuit (including the hydraulic brake release chamber) to empty into reservoir 1, resulting in immediate brake closure.

In addition to the solenoid valve 25, a second solenoid valve 23 can be provided in the secondary manifold 14 at the inlet to the pressure regulator 4. This second solenoid valve 23 is actuated, in the closing direction, by a second progressive stop 24 which is depressed when the operator presses the safety lever 7.

In this case, releasing safety lever 7 not only opens solenoid valve 25, but also closes solenoid valve 23, thereby isolating accumulator 2 from the rest of the circuit. Solenoid valve 23 is optional and complements solenoid valve 25 to ensure very rapid brake closing, avoiding simultaneous emptying and filling of the brake release hydraulic chamber. Solenoid valve 23 thus saves brake release time.

The dead man's safety device shown (with its lever 7, its two solenoid valves and its two progressive stops) is of course only described as a non-limiting example. The person skilled in the art will be able to design a general dead man's safety device using his general knowledge. For example, as a variant a controlled safety device could be provided from client detection such as overspeed, overheating, timing, etc. This variant is less attractive in that it requires the device to be fitted with a battery to supply power to the detection means in the event of a power failure.

In the example shown in FIG. 5, a flow restrictor 37 is also provided between the accumulator and the reservoir. This limiter is used as an ON/OFF valve, to allow the accumulator 2 to be emptied (in ON position) into the reservoir 1, to bring the lowering device to rest.

As part of the lowering method according to the invention, the operator first builds up an energy reserve by inflating the accumulator to maximum capacity using pump 3 or pump 3′. This operation can be repeated as many times as necessary during lowering, taking care first to block the load by reducing the setpoint at the pressure regulator control input.

He then actuates handwheel 5 to increase the pressure in the brake, more or less rapidly, until the load is released. This means it has exceeded the equilibrium pressure in the brake. This equilibrium pressure depends not only on the brake, but also—and especially—on the load (it is not a technical specification of the brake alone), and is therefore unknown to the operator at the start of the lowering operation.

Pressure gauge 9 lets the operator know the value of this equilibrium pressure when the load starts to descend suddenly. He then abruptly turns the handwheel in the opposite direction to apply the brake and stop the load. Now that he knows the approximate equilibrium pressure, the operator can manipulate the handwheel with greater precision, so as to quickly return to approximately this pressure and then gradually exceed it to slide the load. He can then easily control the load's lowering speed by precisely controlling the pressure regulator 4 around the equilibrium pressure.

However, the invention does not require a pressure gauge 9. The operator must then control the regulator blind, without ever knowing the value of the equilibrium pressure. Although not essential, pressure gauge 9 helps reduce operator stress.

Pressure gauge 8 lets the operator know how much energy is stored in accumulator 2. This enables him to anticipate a possible lack of pressure and the need to re-inflate the accumulator. The pressure gauge 8 is an optional component of the lowering device according to the invention, as it is not essential to operator safety or to the success of the lowering process (a lack of pressure at the regulator inlet will cause the brake to close and the load to stop). Like pressure gauge 9, pressure gauge 8 contributes to the ergonomics of the lowering device and helps reduce operator stress.

In addition to the pressure gauges 8 and 9, the lowering device shown in FIG. 5 includes two further pressure taps, namely:
a pressure sensor 28 at the main manifold 13 configured to measure the pressure P1; this sensor 28 theoretically indicates the same measurement as the pressure gauge 8, that is, the pressure P1 delivered by the accumulator,
a pressure sensor 29 in the return circuit between fluid outlet port 18 and pressure limiter 27; this sensor 29 theoretically indicates the same pressure as pressure gauge 9, that is, the pressure delivered by pressure regulator 4, which also corresponds to the pressure in the brake release hydraulic chamber.

These additional sensors can be connected to a recording device or to a remote-control device, for retrospective or remote analysis of the lowering operation.

Lastly, the device according to the invention preferentially comprises a rolling carriage 31 which, in the examples shown, comprises, among other things, wheels 35, two sidewalls 32, 33 connected in particular by a lower plate 36 and by an upper plate 34 on which the collar pressure gauges 8 and 9 and the safety lever 7 are mounted.

1. A hydraulic lowering device for a safety brake of lifting equipment, the safety brake provided with a hydraulic release chamber and a fluid inlet connection the hydraulic lowering device comprising:
a fluid reservoir (1); and
a fluid outlet port (18);
characterized in that the hydraulic lowering device comprises
a pressurized fluid accumulator (2), connected to the fluid reservoir (1);
a pump (3, 3′) connected to the fluid reservoir (1) to inject pressurized fluid from the fluid reservoir (1) into the fluid accumulator (2);
a three-way pressure regulator (4) comprising a mechanical control input for setting a setpoint value, a fluid inlet connected to the fluid accumulator (2), a first fluid outlet connected to the fluid outlet port (18), and a second fluid outlet connected to the fluid reservoir (1);
a device (5) for manual actuation by an operator of the mechanical control input of the three-way pressure regulator (4); and,
an extension for fluidic connection of the fluid outlet port (18) to the fluid inlet connection of the safety brake.

2. The hydraulic lowering device according to claim 1, comprising a safety stop device comprising a safety lever (7) configured to be movable by the operator between a passive locking position which prevents the injection of fluid into the hydraulic release chamber of the safety brake and an active unlocking position which allows the injection of fluid into the hydraulic release chamber of the safety brake, the safety lever (7) being automatically returned to its passive locking position in the absence of action by the operator.

3. The hydraulic lowering device according to claim 2, further comprising a fluid return circuit (30) between the fluid outlet port (18) and the fluid reservoir (1) in parallel with the three-way pressure regulator (4) and wherein the safety stop device comprises:
a first solenoid valve (25) on the fluid return circuit (30), the first solenoid valve (25) configured to be open when the safety lever (7) is in the passive locking position and to be closed when the safety lever is in the active unlocking position, and
a second solenoid valve (23) at the fluid inlet to the three-way pressure regulator (4), the second solenoid valve configured to be closed when the safety lever (7) is in the passive locking position and to be open when the safety lever is in the active unlocking position.

4. The hydraulic lowering device according to claim 1, comprising:
a first pressure sensor (8) for measuring the fluid pressure at the fluid inlet to the three-way pressure regulator (4), and first display means (8) associated with said first pressure sensor (8) for displaying the measured pressure by the first pressure sensor (8); and,
a second pressure sensor (9) for measuring the fluid pressure at the fluid outlet port (18) of the lowering device or at the first fluid outlet of the three-way pressure regulator (4), and second display means (9) associated with said second sensor for displaying the measured pressure by the second pressure sensor (9).

5. The hydraulic lowering device according to claim 4, wherein the first pressure sensor (8) and the first display means are a first pressure gauge (8) capable of measuring pressures up to 250 bar, and the second pressure sensor (9) and the second display means are a second pressure gauge (9) capable of measuring pressures up to 150 bar.

6. The hydraulic lowering device according to claim 1, comprising a fluid return circuit (30) between the fluid outlet port (18) and the fluid reservoir (1) in parallel with the three-way pressure regulator (4).

7. The hydraulic lowering device according to claim 6, wherein the fluid return circuit (30) comprises a pressure limiter (27) configured to limit the fluid pressure injected into the hydraulic release chamber of the safety brake via the fluid outlet port (18).

8. The hydraulic lowering device according to claim 1, comprising a mobile carriage (31) supporting the fluid reservoir (1), the pressurized fluid accumulator (2), the pump (3, 3′), the three-way pressure regulator (4) and the device (5).

9. The hydraulic lowering device according to claim 1, wherein the pump (3, 3′) is selected from: a piston pump (3) manually activated by a lever (10) and a rotary gear pump (3′) associated with a screwdriver (11).

10. The hydraulic lowering device according to claim 1, comprising:
a main manifold (13) to which are connected the fluid reservoir (1) and the pump (3, 3′);
a pressurization hose (15) connecting the pressurized fluid accumulator (2) to said main manifold (13), and
a secondary manifold (14) to which is connected the three-way pressure regulator (4);
a supply hose (16) connecting the pressurized fluid accumulator (2) via the main manifold (13) and the three-way pressure regulator (4); and,
a return hose (17) connecting the fluid reservoir (1) via the main manifold (13) and the fluid outlet port (18).

11. The hydraulic lowering device according to claim 1, further comprising a pressure limiter (22) between the pressurized fluid accumulator (2) and the fluid reservoir (1), the pressure limiter (22) configured to limit the fluid pressure injected into the pressurized fluid accumulator (2).

12. A method of lowering a load on lifting equipment, characterized in that it uses the hydraulic lowering device according to claim 1, and in that it comprises:
pressurizing the pressurized fluid accumulator (2), during which at least some of the fluid present in the fluid reservoir (1) is injected into the pressurized fluid accumulator (2) by activating the pump (3, 3′); and,
controlling the pressure at the first fluid outlet of the three-way pressure regulator (4) by means of the device (5) so as to control the lowering of the load carried by the lifting equipment
wherein the pressurizing and controlling steps are carried out successively, independently of one another.
